(19) United States
(12) Patent Application Publication
(10) Pub. No.: US 2024/0335944 A1
(43) Pub. Date: Oct. 10, 2024

(54) Method of Controlling Industrial Device Comprising Manipulator, Control System and Industrial Device

(71) Applicant: ABB Schweiz AG, Baden (CH)

(72) Inventors: Markus Enberg, Västerås (SE); Hans Andersson, Västerås (SE)

(21) Appl. No.: 18/681,972

(22) PCT Filed: Sep. 1, 2021
(86) PCT No.: PCT/EP2021/074112

§ 371 Date: Feb. 7, 2024

(51) Int. Cl. B25J 9/16; B25J 11/00

(52) U.S. Cl. CPC B25J 9/1664; B25J 11/005

(57) ABSTRACT

A method of controlling an industrial device including a manipulator, the method including providing a plurality of consecutive target points for the manipulator; providing a plurality of alternative zone groups, where each zone group includes at least one zone associated with a target point; for each zone group, evaluating a performance value of a performance parameter of the industrial device, the performance parameter being associated with execution by the manipulator of a movement path associated with the target points and the at least one zone; selecting one of the zone groups based on the evaluation; and controlling the industrial device based on the selected zone group, the control including executing the movement path associated with the selected zone group by the manipulator. A control system and an industrial device are also provided.

### TECHNICAL FIELD

The present disclosure generally relates to control of a robotic manipulator. In particular, a method of controlling an industrial device comprising a manipulator, a control system for controlling an industrial device comprising a manipulator, and an industrial device comprising a manipulator and a control system, are provided.

### BACKGROUND

A robot program for a robotic manipulator typically comprises a plurality of programmed target points for determining a movement path of a tool center point (TCP) associated with an end effector of the manipulator. The robot program can determine a fully defined movement path between consecutive target points, for example by assuming linear or spline interpolations of consecutive movement segments between the target points.

It is previously known to define a fly-by zone associated with one or more target points of the movement path. The target points may then be referred to as fly-by points. By defining a fly-by zone around a fly-by point, the fly-by point is never attained by the TCP when executing the movement path since the direction of motion is changed before the target point is reached, given that an outgoing movement segment is inclined relative to an incoming movement segment.

It is also known to define reorientation zones and secondary zones associated with the target points. An orientation of the end effector may be programmed to change from a first orientation to a second orientation during the time when the TCP passes through a reorientation zone. Similarly, a secondary actuator may be programmed to change from a first state (such as a first position or an on state) to a second state (such as a second position or an off state) during the time when the TCP passes through the secondary zone. The first and second states may be different poses (positions and orientations) of the secondary actuator.

In many applications, a smooth movement path is desired to obtain a smooth motion of the manipulator. In this way, the cycle time can often be reduced. The smooth movement path can be obtained by selecting relatively large fly-by zones.

WO 2020007458 A1 discloses a method for controlling an industrial actuator, the method comprising defining a movement path as a sequence of a plurality of consecutive movement segments, where each movement segment is defined between two points; defining at least one blending zone associated with one of the points between two consecutive movement segments, wherein the blending zone is defined independently in relation to each of the two consecutive movement segments; and executing the movement path comprising the blending zone by the industrial actuator.

### SUMMARY

Today, zones associated with target points for a robotic manipulator are typically defined manually by a human user. It may however be very difficult to know how the zones should be selected to provide an optimal performance for a particular implementation of the manipulator or of an industrial device comprising the manipulator, even for experienced users. Optimal definitions of the zones are heavily dependent on the particular implementation.

Moreover, a multitude of parameters are often available to define the zones and the zones may be of at least three different types (fly-by zones, reorientation zones and secondary zones). Although the zones may be set with a default size, there is no further assistance for the user in defining the zones.

Users often program with the wrong, typically smaller, zones compared to what is optimal for a given application. It may however not always be optimal to make the zones as large as possible. For example, in conveyor tracking, a vertical distance of a pick and place path of the manipulator is normally very short in comparison with the horizontal distances to move the objects between picking points and placing points. In such application, it may not be suitable to extend fly-by zones as much as possible. Large fly-by zones may also increase the risk of the manipulator entering a singularity with a consequential stop of the manipulator.

One object of the present disclosure is to provide an improved method of controlling an industrial device comprising a manipulator.

A further object of the present disclosure is to provide a method of controlling an industrial device comprising a manipulator, which method enables an improved performance of the manipulator and/or of the industrial device.

A still further object of the present disclosure is to provide a method of controlling an industrial device, which method enables improved definitions of zones associated with target points.

A still further object of the present disclosure is to provide a method of controlling an industrial device, which method is easy to use by a user.

A still further object of the present disclosure is to provide a method of controlling an industrial device, which method solves several or all of the foregoing objects in combination.

A still further object of the present disclosure is to provide a control system for controlling an industrial device comprising a manipulator, which control system solves one, several or all of the foregoing objects.

A still further object of the present disclosure is to provide an industrial device comprising a manipulator and a control system, which industrial device solves one, several or all of the foregoing objects.

According to a first aspect, there is provided a method of controlling an industrial device comprising a manipulator, the method comprising providing a plurality of consecutive target points for the manipulator; providing a plurality of alternative zone groups, where each zone group comprises at least one zone associated with a target point; for each zone group, evaluating a performance value of a performance parameter of the industrial device, the performance parameter being associated with execution by the manipulator of a movement path associated with the target points and the at least one zone; selecting one of the zone groups based on the evaluation; and controlling the industrial device based on the selected zone group, the control comprising executing the movement path associated with the selected zone group by the manipulator.

By evaluating performance values for several different zone groups and selecting one of the zone groups based on the evaluation, a better performance of the industrial device can be obtained. The zone group having the best performance value may thus be selected. The performance parameter may be some criteria associated with the industrial device and the target points that can be measured or classified. Examples of performance parameters comprise a total or partial time of executing the movement path by the manipulator, a total or maximum wear on the industrial device when executing the movement path by the manipulator, a maximum force or a maximum torque acting on the industrial device when executing the movement path by the manipulator, and a singularity parameter indicating an occurrence of a singularity of the manipulator.

The target points may be programmed positions in a robot program of the industrial device. The target points may be input by a user and/or may be determined by the robot program.

The method may employ an algorithm where the target points are input to the algorithm. Based on the target points, the algorithm may provide the alternative zone groups, evaluate the performance parameters, and select one of the one zone groups. The algorithm may output the selected zone group and a movement path associated therewith for execution by the manipulator.

The method may be carried out online in real time with a look ahead function. For example, the method may be carried out for a group of downstream target points at the same time as the manipulator executes a movement path associated with a group of upstream target points. Thus, the manipulator does not necessarily have to be stopped to carry out the method. Furthermore, the zones associated with the downstream target points may in this case be affected by the zones associated with the upstream target points.

Alternatively, the provision of the target points, the provision of the alternative zone groups, the evaluation of the performance values and the selection of one of the zone groups may be carried out offline.

Each zone may define a behavior of the industrial device when the manipulator moves through the zone. Each zone group may have at least one unique zone associated with one of the target points. Each zone group is thereby unique.

The method may be carried out automatically by means of a robot program implemented in a control system controlling the industrial device. Based on a set of target points, the user can optionally let the robot program completely determine the zones.

The method may further comprise providing one or more constraints for the industrial device. In this case, the provision of the plurality of alternative zone groups and/or the evaluation of the performance value for each zone group may be made based on these one or more constraints. The one or more constraints may be input by a user and/or may be determined by the robot program.

Examples of constraints may comprise maximum speeds and accelerations of the manipulator (e.g. the end effector thereof) and spatial constraints, such as objects in the workspace of the manipulator that should not be collided with. The maximum speeds and accelerations of the end effector may be defined inside one or more of the zones, between the zones and/or for the overall movement path.

Further examples of constraints may comprise time steps of the control system, time steps of one or more motors driving joints of the manipulator or of the industrial device, or some other discretization time associated with the industrial device, i.e. a degree of discretization of the control of the industrial device. Thus, the provision of the plurality of alternative zone groups and/or the evaluation of the performance value for each zone group may be made at least partly based on one or more discretization values. In this way, it can be made sure that differences between the alternative zone groups are not in reality cancelled by discretization, and that the alternative zone groups actually provide different performances.

The evaluation may comprise checking whether the manipulator would enter or come close to a singularity during execution of the movement path. The performance value may then reflect the result of this check, e.g. by means of a large time in the presence of singularity and/or by means of a binary number.

The manipulator may be a robotic manipulator programmable in three or more axes, such as in six or seven axes. The manipulator may be a serial manipulator or a parallel manipulator.

The zones may be defined in space in a coordinate system used by the manipulator. Each zone may comprise a geometric shape. The zones may be two-dimensional and/or three-dimensional. Examples of shapes for the zones include spheres, ellipsoid, cuboids, circles, ellipses and rectangles. The zones may be symmetric and/or asymmetric.

Each zone group may comprise one or more fly-by zones. In this case, the performance parameter may be associated with execution by the manipulator of a movement path created based on the target points and the at least one fly-by zone of the zone group.

Throughout the present disclosure, the fly-by zones may alternatively be referred to as position blending zones or Cartesian position blending zones. In a fly-by zone associated with a target point, an incoming movement segment to the target point may be blended with an outgoing movement segment from the target point. The two movement segments may thereby be executed simultaneously inside the fly-by zone. The fly-by zones are thus used to specify how a first of two consecutive movement segments is to be terminated and how a second of the two consecutive movement segments is to be initiated, i.e. how close to the target point the TCP must be before moving towards the next point.

In case the zone groups differ from each other by the definitions of the one or more fly-by zones, each zone group will be associated with a unique geometric movement path for the manipulator. The method according to this variant enables an automatic movement path characteristic selection for the manipulator.

The method may further comprise, for each zone group, creating a movement path based on the target points and the at least one fly-by zone of the zone group. In this case, the evaluation may be made based on the created movement paths. As a possible alternative, the performance values may be calculated without necessarily creating the movement path for each zone group.

The evaluation may comprise, for each movement path, simulating the control of the industrial device. The simulations may alternatively be referred to as ghost runs. The simulation enables an improved (in some respect) zone group to be found faster in comparison with manually testing and analyzing each alternative zone group. The simulations may be carried out by means of a simulation software implemented in the control system.

The method may further comprise providing at least one additional zone group based on the evaluation. In this case, the selection may be made also based on the at least one additional zone group. The steps of providing zone groups and evaluating performance values of the zone groups may thus be performed iteratively. The at least one additional zone group may be determined by an optimization algorithm, e.g. implemented in the control system.

The method may further comprise receiving a selection indicative of the performance parameter among a plurality of different performance parameters from a user prior to evaluating the performance values. Thus, the user may select which performance parameter that should be improved by the selection of one of the zone groups. The user may for example provide an input indicating that the control of the industrial device should be executed as fast as possible or with as low wear as possible.

The method may further comprise determining an actual performance value of the performance parameter based on the control of the industrial device; and modifying the selected zone group based on the actual performance value. The modification of the selected zone group based on the actual performance value may be made by an optimization algorithm. The zone group may for example be modified and improved every time the movement path is executed. In this way, a zone group can be repeatedly improved over several cycles of control of the industrial device.

The at least one zone may comprise one or more reorientation zones. In this case, the method may further comprise controlling reorientation of an end effector of the manipulator based on the reorientation zones when executing the movement path by the manipulator. The method according to this variant enables an automatic reorientation characteristic selection for the manipulator. A reorientation movement of the end effector may be programmed to occur when the TCP passes through the reorientation zone.

For a zone group comprising one or more fly-by zones, an optimal set of one or more reorientation zones can be stored. Optimal reorientation zones can then be used automatically in case the same movement path occurs again.

In case the zone groups differ from each other by the definition of the one or more reorientation zones, each zone group will define a unique reorientation characteristic for the end effector, even for identic movement paths. The movement paths may be identic if the fly-by zones are identic between zone groups or if no fly-by zones are used.

In some cases, the end effector may be controlled to move along a single straight line comprising a plurality of target points. In this case, different reorientation zones associated with the target points will cause different reorientation behavior of the end effector when moving along the straight line.

The at least one zone may comprise one or more secondary zones. In this case, the method may further comprise controlling actuation of a secondary actuator of the industrial device based on the secondary zones when executing the movement path by the manipulator. The secondary actuator may be independent from the manipulator, e.g. such that the secondary actuator can be moved while the manipulator remains stationary. The method according to this variant enables an automatic control characteristic of a secondary actuator of the industrial device. An actuation of a secondary actuator may be programmed to occur when the TCP passes through the secondary zone.

The secondary actuator may be programmed in at least one axis. One example of such secondary actuator is a support rotatable about one axis. Alternatively, or in addition, the secondary actuator may be controlled between different states in dependence of the position of the TCP in relation to the one or more secondary zones. The secondary actuator may for example be a painting device where spraying of paint occurs while the TCP moves through the secondary zone.

For a zone group comprising one or more fly-by zones, an optimal set of one or more secondary zones can be stored. Optimal secondary zones can then be used automatically in case the same movement path occurs again.

According to a second aspect, there is provided a control system for controlling an industrial device comprising a manipulator, the control system comprising at least one data processing device and at least one memory having at least one computer program stored thereon, the at least one computer program comprising program code which, when executed by the at least one data processing device, causes the at least one data processing device to perform the steps of providing a plurality of consecutive target points for the manipulator; providing a plurality of alternative zone groups, where each zone group comprises at least one zone associated with a target point; for each zone group, evaluating a performance value of a performance parameter of the industrial device, the performance parameter being associated with execution by the manipulator of a movement path associated with the target points and the at least one zone; selecting one of the zone groups based on the evaluation; and controlling the industrial device based on the selected zone group, the control comprising commanding execution of the movement path associated with the selected zone group by the manipulator.

The at least one computer program may further comprise program code which, when executed by the at least one data processing device, causes the at least one data processing device to perform, or command performance of, any step according to the present disclosure.

Each zone group may comprise one or more fly-by zones. The performance parameter may be associated with execution by the manipulator of a movement path created based on the target points and the at least one fly-by zone of the zone group. In this case, the at least one computer program may further comprise program code which, when executed by the at least one data processing device, causes the at least one data processing device to, for each zone group, create a movement path based on the target points and the at least one fly-by zone of the zone group.

The evaluation may be made based on the created movement paths. Alternatively, or in addition, the evaluation may comprise, for each movement path, simulating the control of the industrial device.

The at least one computer program may further comprise program code which, when executed by the at least one data processing device, causes the at least one data processing device to provide at least one additional zone group based on the evaluation. In this case, the selection may be made also based on the at least one additional zone group.

The at least one computer program may further comprise program code which, when executed by the at least one data processing device, causes the at least one data processing device to receive a selection indicative of the performance parameter among a plurality of different performance parameters from a user prior to evaluating the performance values.

The at least one computer program may further comprise program code which, when executed by the at least one data processing device, causes the at least one data processing device to determine an actual performance value of the performance parameter based on the control of the industrial device; and modify the selected zone group based on the actual performance value.

The at least one zone may comprise one or more reorientation zones. In this case, the at least one computer program may further comprise program code which, when executed by the at least one data processing device, causes the at least one data processing device to control reorientation of an end effector of the manipulator based on the reorientation zones when executing the movement path by the manipulator.

The at least one zone may comprise one or more secondary zones. In this case, the at least one computer program may further comprise program code which, when executed by the at least one data processing device, causes the at least one data processing device to control actuation of a secondary actuator of the industrial device based on the secondary zones when executing the movement path by the manipulator.

According to a third aspect, there is provided an industrial device comprising the manipulator and a control system according to the second aspect. The industrial device may further comprise the secondary actuator. In case the industrial device does not comprise the secondary actuator, the industrial device may be an industrial robot comprising the manipulator and the control system.

### BRIEF DESCRIPTION OF THE DRAWINGS

Further details, advantages and aspects of the present disclosure will become apparent from the following description taken in conjunction with the drawings, wherein:

FIG. 1: schematically represents an industrial device comprising a manipulator and a secondary actuator;

FIG. 2a: schematically represents a plurality of target points for the manipulator and one example of a zone group comprising fly-by zones;

FIG. 2b: schematically represents a movement path for the manipulator associated with the zone group in FIG. 2a;

FIG. 3a: schematically represents the target points of FIG. 2a and a further example of a zone group comprising fly-by zones;

FIG. 3b: schematically represents a movement path for the manipulator associated with the zone group in FIG. 3a;

FIG. 4a: schematically represents the target points of FIG. 2a and a further example of a zone group comprising fly-by zones;

FIG. 4b: schematically represents a movement path for the manipulator associated with the zone group in FIG. 4a;

FIG. 5a: schematically represents the target points of FIG. 2a and a further example of a zone group comprising fly-by zones;

FIG. 5b: schematically represents a movement path for the manipulator associated with the zone group in FIG. 5a;

FIG. 6a: schematically represents the target points of FIG. 2a and a further example of a zone group comprising fly-by zones;

FIG. 6b: schematically represents a movement path for the manipulator associated with the zone group in FIG. 6a;

FIG. 7a: schematically represents the target points of FIG. 2a and a further example of a zone group comprising fly-by zones and reorientation zones;

FIG. 7b: schematically represents a movement path for the manipulator associated with the zone group in FIG. 7a;

FIG. 8a: schematically represents the target points of FIG. 2a and a further example of a zone group comprising only reorientation zones;

FIG. 8b: schematically represents a movement path for the manipulator associated with the zone group in FIG. 8a;

FIG. 9a: schematically represents the target points of FIG. 2a and a further example of a zone group comprising fly-by zones and secondary zones; and

FIG. 9b: schematically represents a movement path for the manipulator and a control of the secondary actuator associated with the zone group in FIG. 9a.

### DETAILED DESCRIPTION

In the following, a method of controlling an industrial device comprising a manipulator, a control system for controlling an industrial device comprising a manipulator, and an industrial device comprising a manipulator and a control system, will be described. The same or similar reference numerals will be used to denote the same or similar structural features.

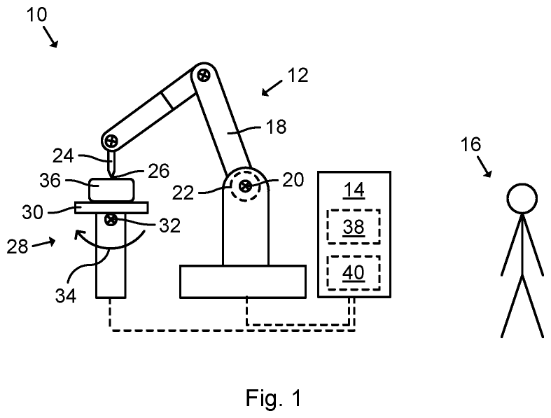

FIG. 1 schematically represents an industrial device 10. The industrial device comprises a robotic manipulator 12 and a control system 14, here exemplified as a robot controller. FIG. 1 further shows a human user 16 next to the industrial device 10.

The manipulator 12 of this example is a serial manipulator comprising a plurality of links 18 and a plurality of intermediate joints or axes 20. The manipulator 12 may for example comprise six or seven axes 20. The manipulator 12 further comprises a plurality of electric manipulator motors 22, one associated with each axis 20. Each axis 20 may be either rotational or translational.

The manipulator 12 further comprises an end effector 24. FIG. 1 further shows a tool center point, TCP, 26 of the manipulator 12. The TCP 26 is defined in fixed relationship to the end effector 24, typically at the tip thereof as in FIG. 1.

The industrial device 10 of this example further comprises an optional secondary actuator 28. The secondary actuator 28 is here exemplified as comprising a reorientable table 30. The secondary actuator 28 may however, for example, alternatively be an additional robotic manipulator.

The secondary actuator 28 of this specific example is configured to rotate the table 30 about a horizontal secondary axis 32, as illustrated with arrow 34. The table 30 may however be moved in two or more axes, for example up to six axes. An object 36 is secured to the table 30. The end effector 24 may for example be a welding tool or other type of tool for performing a handling operation on the object 36. The secondary actuator 28 may comprise a secondary electric motor for driving each axis thereof.

The control system 14 is configured to control the manipulator 12 and the secondary actuator 28 according to the present disclosure. The control system 14 here comprises a data processing device 38 (e.g. a central processing unit, CPU) and a memory 40. A robot program is stored in the memory 40. The robot program comprises program code which, when executed by the data processing device 38, causes the data processing device 38 to perform, or command performance of, various steps as described herein in connection with a method of controlling the industrial device 10. The control system 14 is in signal communication with each of the manipulator 12 and the secondary actuator 28.

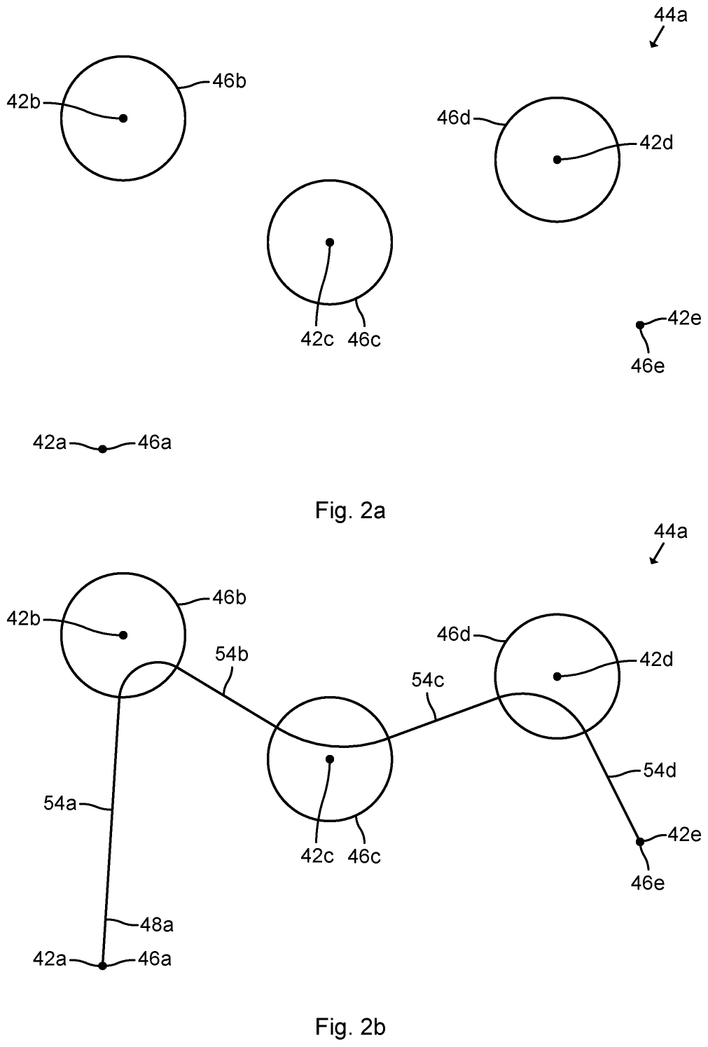

FIG. 2a schematically represents a plurality of target points 42a-42e for the manipulator 12. FIG. 2a shows a first target point 42a, a second target point 42b, a third target point 42c, a fourth target points 42d and a fifth target point 42e. When executing a robot program involving the target points 42a-42e, the TCP 26 may reach, or almost reach, each target point 42a-42e in a defined order (here first to fifth).

Each target point 42a-42e is defined as a position in space, e.g. in a Cartesian coordinate system. The target points 42a-42e may be automatically generated by the robot program or may be programmed by the user 16, for example by jogging the manipulator 12, by means of lead-through, or by inputting numerical values representing the target points 42a-42e.

FIG. 2a further shows one example of a zone group 44a. The zone group 44a of this example comprises five zones 46a-46e. FIG. 2a shows a first zone 46a associated with the first target point 42a, a second zone 46b associated with the second target point 42b, a third zone 46c associated with the third target point 42c, a fourth zone 46d associated with the fourth target point 42d, and a fifth zone 46e associated with the fifth target point 42e. The second, third and fourth zones 46b, 46c and 46d are here fly-by zones defined as spheres centered on the second, third and fourth target points 42b, 42c and 42d, respectively, and having the same radius. The first and fifth zones 46a and 46e are here fine or zero zones (with zero radius) where the TCP 26 makes a full stop.

FIG. 2b schematically represents a movement path 48a for the manipulator 12 associated with the zone group 44a. The movement path 48a may be two-dimensional or three-dimensional. When executing the robot program, the TCP 26 follows the movement path 48a.

The movement path 48a is created based on the target points 42a-42e and the zones 46a-46e. The movement path 48a comprises a first movement segment 54a between the first zone 46a and the second zone 46b, a second movement segment 54b between the second zone 46b and the third zone 46c, a third movement segment 54c between the third zone 46c and the fourth zone 46d, and a fourth movement segment 54d between the fourth zone 46d and the fifth zone 46e. The movement segments 54a-54d may be generated by the robot program, for example by means of interpolation. The interpolation can be made with different types of Cartesian base functions, such as lines, circle segments and splines. Also an interpolation in joint coordinates of the industrial actuator and/or an interpolation for tool orientation is possible.

Since the first and fifth zones 46a, 46e are fine zones, the TCP 26 starts at standstill at the first target point 42a and ends at standstill at the fifth target point 42e. As shown in FIG. 2b, the first and second movement segments 54a and 54b are blended inside the second zone 46b. As a result, the TCP 26 will not reach the second target point 42b when following the movement path 48a. The same applies for the second and third movement segments 54b and 54c with respect to the third zone 46c, and for the third and fourth movement segments 54c and 54d with respect to the fourth zone 46d.

Although the fly-by zones 46b-46d are here exemplified as spheres, the fly-by zones 46b-46d may alternatively be defined by means of two zone borders, where each zone border is defined in relation to the two movement segments 54a-54d adjacent to the respective fly-by zone 46b-46d. Alternatively, or in addition, each fly-by zone may be defined with a factor from 0 to 1, or with a percentage of between 0% and 100%, in relation to each of the two adjacent movement segments 54a-54d.

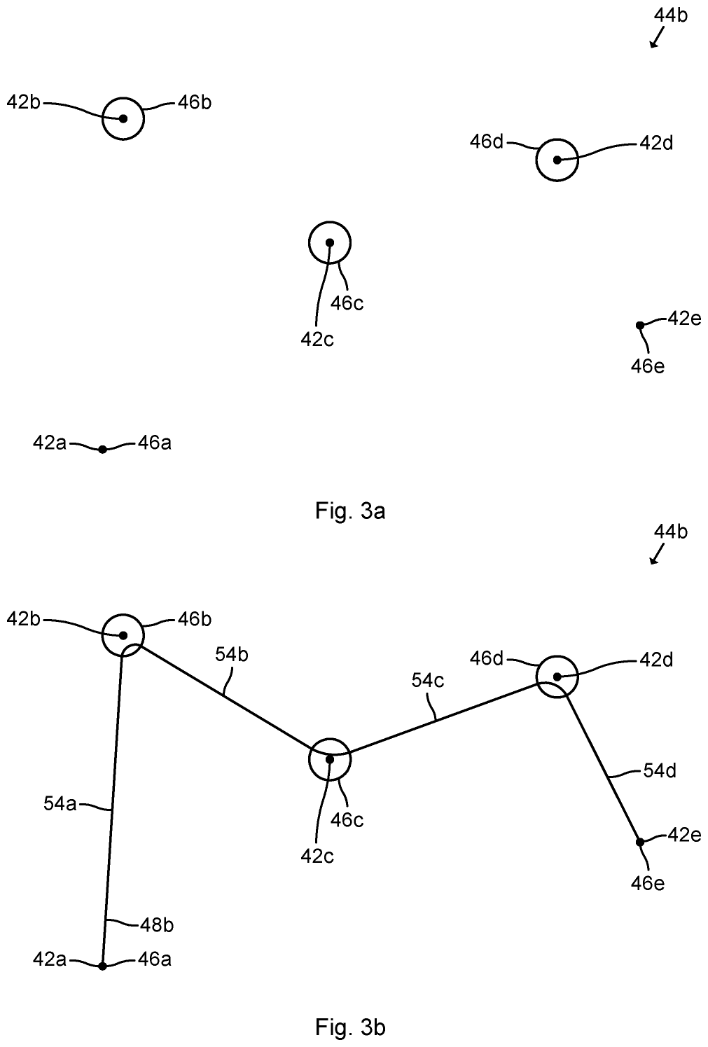

FIG. 3a schematically represents the target points 42a-42e and a further example of a zone group 44b comprising zones 46a-46e, and FIG. 3b schematically represents a movement path 48b for the manipulator 12 associated with the zone group 44b. With collective reference to FIGS. 3a and 3b, the zone group 44b differs from the zone group 44a in that the fly-by zones 46b-46d are smaller than the fly-by zones 46b-46d of the zone group 44a. As a consequence, the movement path 48b comes closer to the target points 42b-42d. The movement path 48b is thereby more accurate and less smooth than the movement path 48a. When the fly-by zones 46b-46d are too small, the speed along the movement path 48b may however be jerky.

During control of the manipulator 12 to execute the movement path 48b, there is a certain discretization. For this reason, the movement segments 54a-54d cannot be made infinitely small. In case the target points 42a-42e are positioned very close to each other, the speed along the movement path 48b will be reduced since the manipulator 12 will have to wait at least one time step in each movement segment 54a-54d and in each zone 46a-46e in order not to skip one or more of the movement segment 54a-54d and the zones 46a-46e.

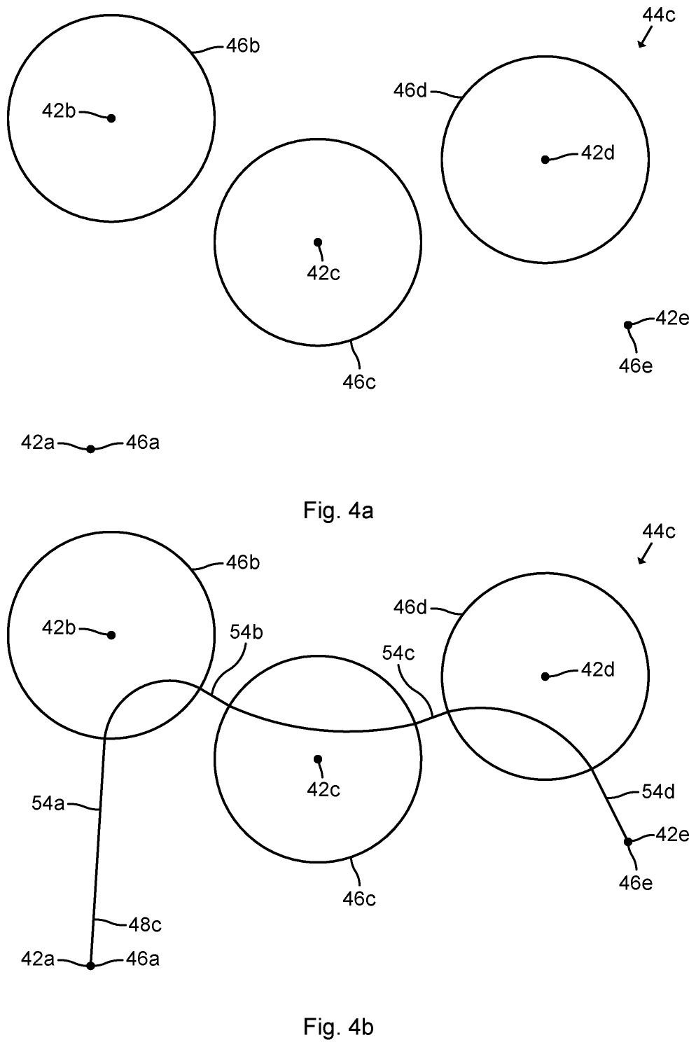

FIG. 4a schematically represents the target points 42a-42e and a further example of a zone group 44c comprising zones 46a-46e, and FIG. 4b schematically represents a movement path 48c for the manipulator 12 associated with the zone group 44c. With collective reference to FIGS. 4a and 4b, the zone group 44c differs from the zone group 44a in that the fly-by zones 46b-46d are larger than the fly-by zones 46b-46d of the zone group 44a. As a consequence, the movement path 48c comes further away from the target points 42b-42d. The movement path 48c is thereby less accurate but smoother than the movement path 48a.

In the method of controlling the industrial device 10 as described herein, the zone groups 44a-44c may represent an initial set of alternative zone groups 44a-44c. That is, the alternative zone groups 44a-44c may comprise a first zone group 44a having fly-by zones 46b-46d of a first unique size, a second zone group 44b having fly-by zones 46b-46d of a second unique size, and a third zone group 44c having fly-by zones 46b-46d of a third unique size.

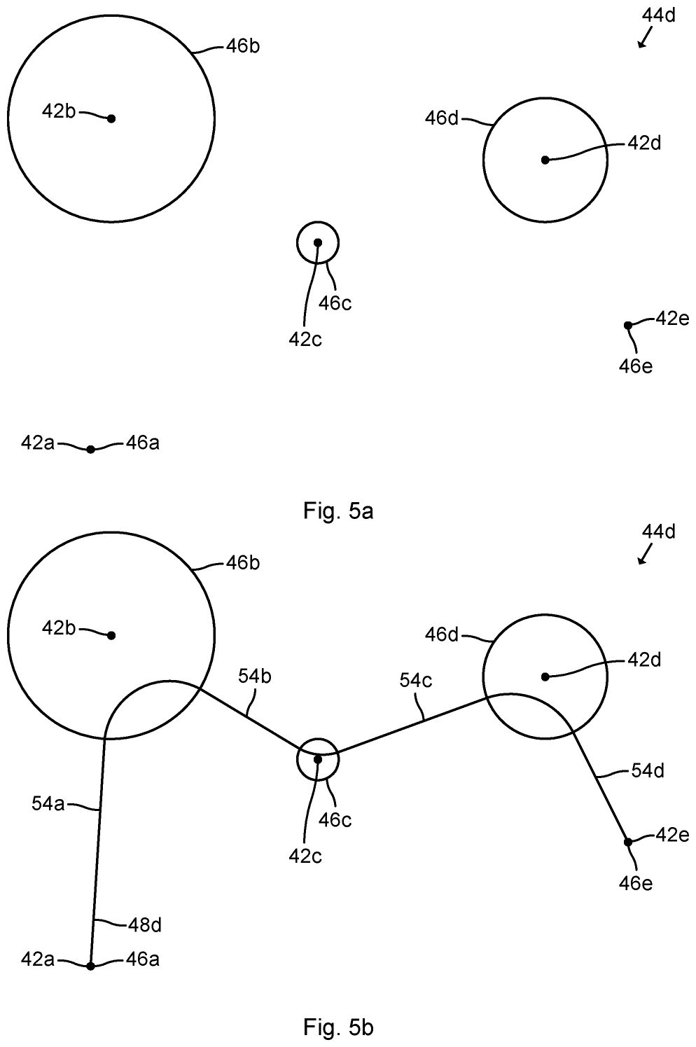

FIG. 5a schematically represents the target points 42a-42e and a further example of a zone group 44d comprising zones 46a-46e, and FIG. 5b schematically represents a movement path 48d for the manipulator 12 associated with the zone group 44d. With collective reference to FIGS. 5a and 5b, the zone group 44d differs from the zone groups 44a-44c in that the fly-by zones 46b-46d each has a unique size. The second zone 46b is large, the third zone 46c is small, and the fourth zone 46d is of an intermediate size.

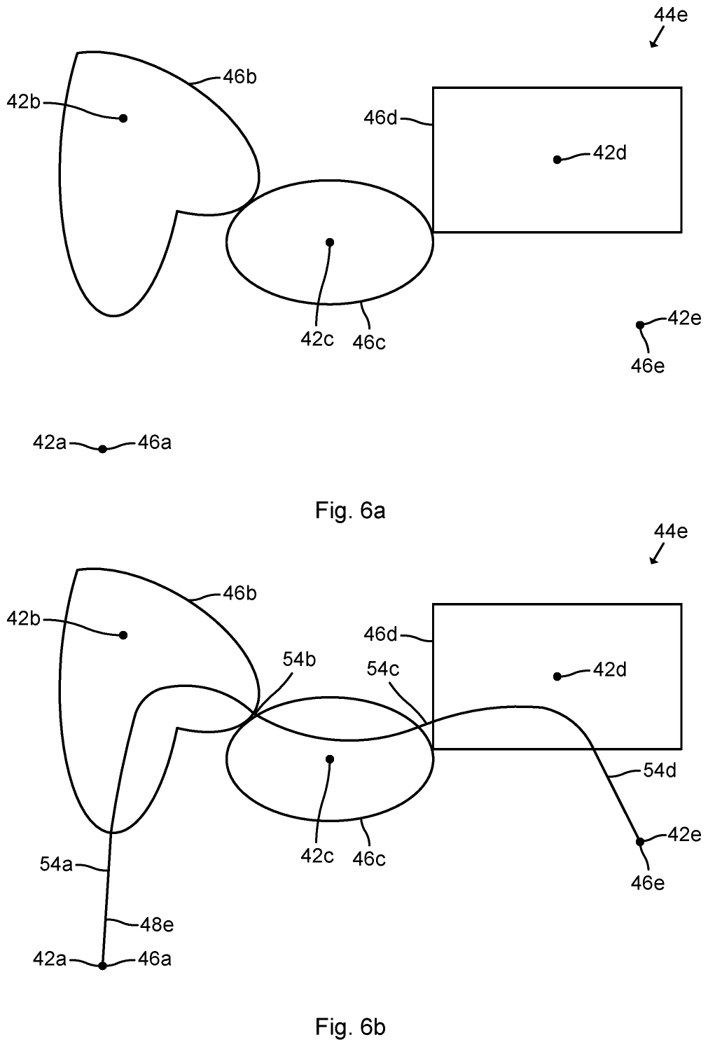

FIG. 6a schematically represents the target points 42a-42e and a further example of a zone group 44e comprising zones 46a-46e, and FIG. 6b schematically represents a movement path 48e for the manipulator 12 associated with the zone group 44e. With collective reference to FIGS. 6a and 6b, the zone group 44e differs from the zone groups 44a-44d in that each fly-by zone 46b-46d has a unique shape and size. The fly-by zones 46b-46d are not spheres in this example. The second zone 46b is exemplified as a three-dimensional shape based on a combination of two ellipses, the third zone 46c is exemplified as an ellipsoid, and the fourth zone 46d is exemplified as a cuboid.

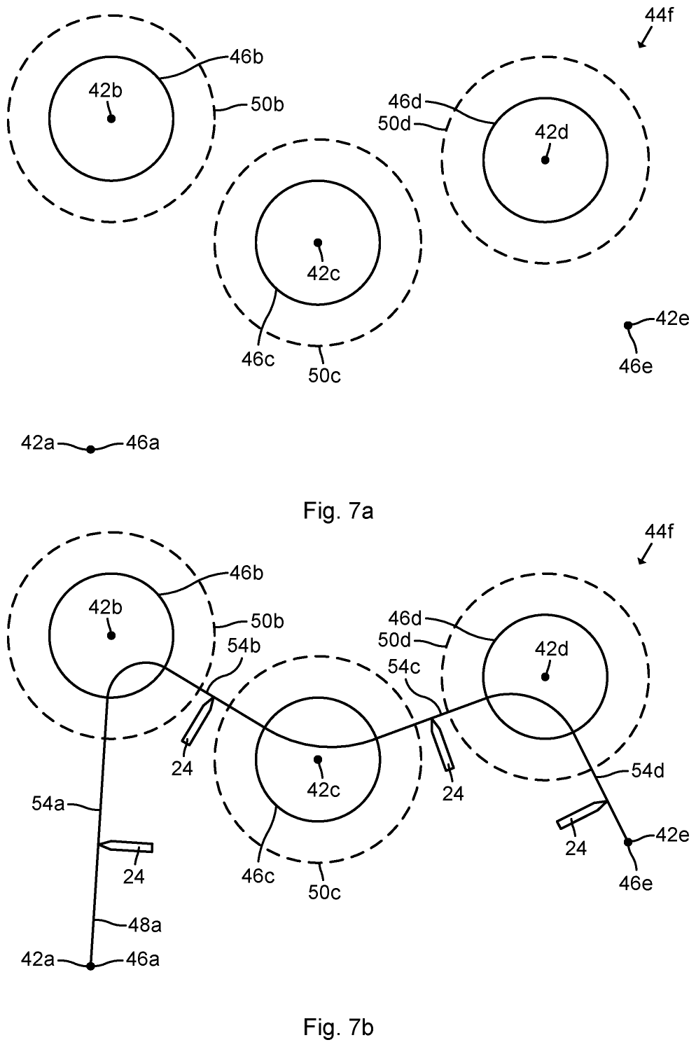

FIG. 7a schematically represents the target points 42a-42e and a further example of a zone group 44f, and FIG. 7b schematically represents a movement path 48a for the manipulator 12 associated with the zone group 44f. The zone group 44f comprises fine zones and fly-by zones 46a-46e identical to those of the zone group 44a. For this reason, the movement path 48a is common for the zone groups 44a and 44f. However, the zone group 44f further comprises three reorientation zones 50b-50d. The reorientation zones 50b-50d are here exemplified as spheres but may be defined in various different ways and shapes. A second reorientation zone 50b is associated with the second target point 42b, a third reorientation zone 50c is associated with the third target point 42c, and a fourth reorientation zone 50d is associated with the fourth target point 42d.

During execution of the movement path 48a by the manipulator 12, the TCP 26 follows the movement path 48a. However, reorientation of the end effector 24 is performed when the TCP 26 is inside one of the reorientation zones 50b-50d. As shown in FIG. 7b, the end effector 24 is reoriented in the second reorientation zone 50b from a first orientation associated with the first movement segment 54a to a second orientation associated with the second movement segment 54b. When the TCP 26 is in the third reorientation zone 50c, the end effector 24 is reoriented from the second orientation to a third orientation associated with the third movement segment 54c. When the TCP 26 is in the fourth reorientation zone 50d, the end effector 24 is reoriented from the third orientation to a fourth orientation associated with the third movement segment 54d.

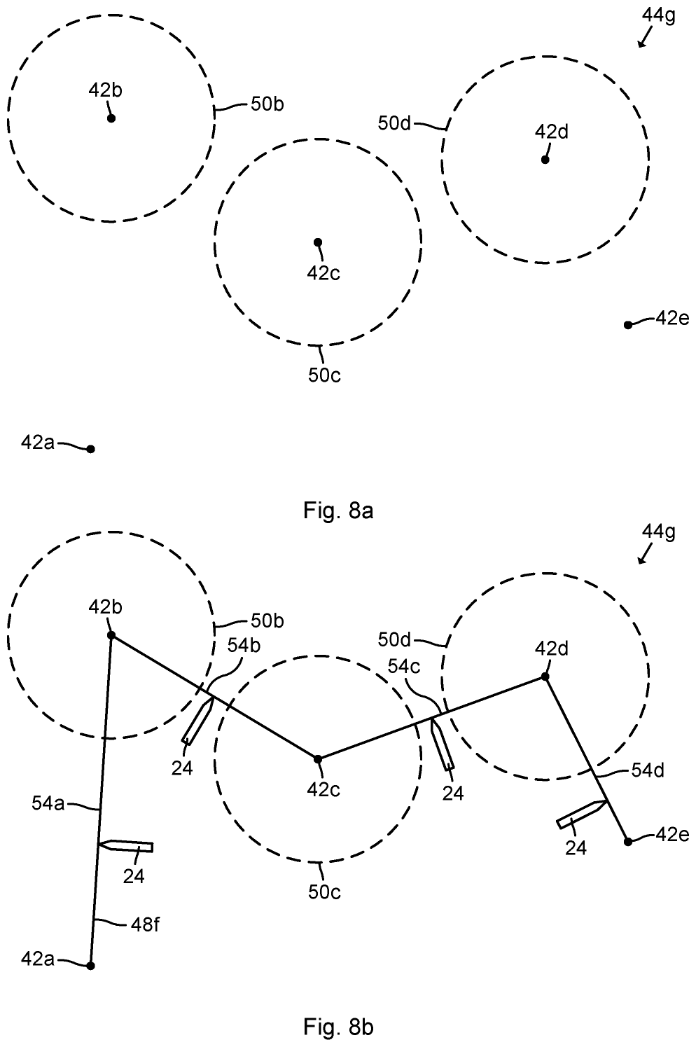

FIG. 8a schematically represents the target points 42a-42e and a further example of a zone group 44g, and FIG. 8b schematically represents a movement path 48f for the manipulator 12 associated with the zone group 44g. With collective reference to FIGS. 8a and 8b, the zone group 44g differs from the zone group 44f in that the zone group 44g does not comprise any fly-by zones. Thus, each target point 42a-42e becomes a fine zone that the TCP 26 will reach when executing the movement path 48f by the manipulator 12. For this reason, the movement path 48f differs from the movement path 48a.

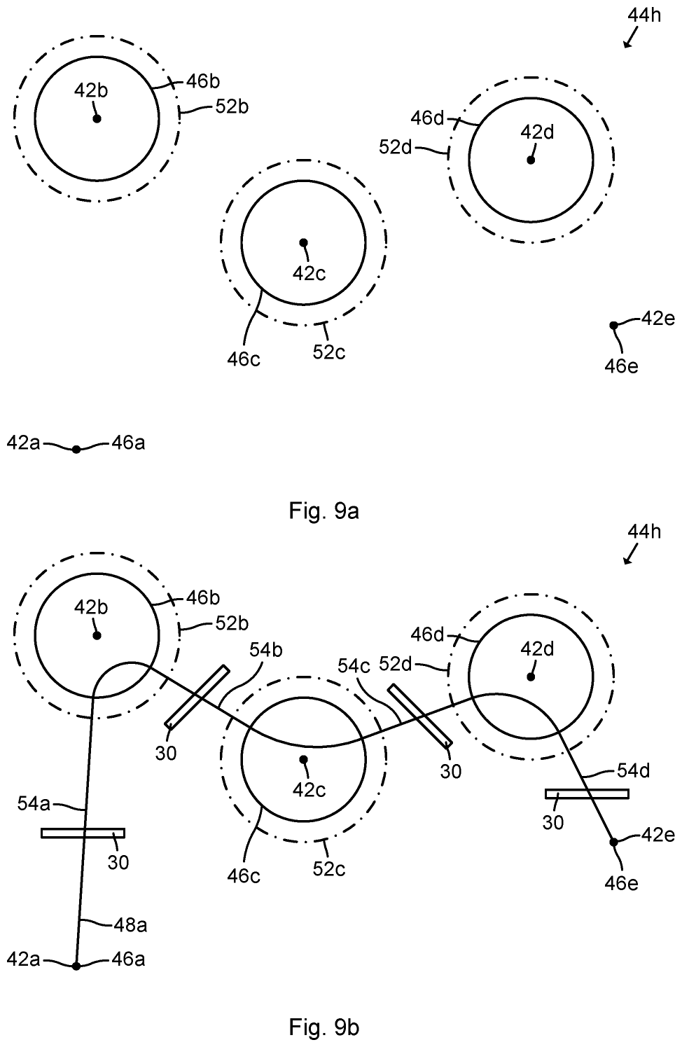

FIG. 9a schematically represents the target points 42a-42e and a further example of a zone group 44h, and FIG. 9b schematically represents a movement path 48a for the manipulator 12 and a control of the secondary actuator 28 associated with the zone group 44h in FIG. 9a. With collective reference to FIGS. 9a and 9b, the zone group 44h comprises fine zones and fly-by zones 46a-46e identical to those of the zone group 44a. For this reason, the movement path 48a is common for the zone groups 44a and 44h. However, the zone group 44h further comprises three secondary zones 52b-52d. The secondary zones 52b-52d are here exemplified as spheres but may be defined in various different ways and shapes. A second secondary zone 52b is associated with the second target point 42b, a third secondary zone 52c is associated with the third target point 42c, and a fourth secondary zone 52d is associated with the fourth target point 42d.

During execution of the movement path 48a associated with the zone group 44h by the manipulator 12, the TCP 26 follows the movement path 48a. However, control of the secondary actuator 28 is performed in conjunction with the TCP 26 entering and exiting the secondary zones 52b-52d. As shown in FIG. 9b, when the TCP 26 is inside the second secondary zone 52b, the secondary actuator 28 controls the table 30 to move from a first orientation associated with the first movement segment 54a to a second orientation associated with the second movement segment 54b. When the TCP 26 is inside the third secondary zone 52c, the secondary actuator 28 controls the table 30 to move from the second orientation to a third orientation associated with the third movement segment 54c. When the TCP 26 is inside the fourth secondary zone 52d, the secondary actuator 28 controls the table 30 to move from the third orientation to a fourth orientation associated with the fourth movement segment 54d.

The method of controlling the industrial device 10 enables an improved generation of zones 46a-46e associated with the target points 42a-42e. The user 16 may select the performance parameter among a plurality of different performance parameters. The user 16 may for example select whether the industrial device 10 should be controlled to move fast or with low wear. A corresponding selection input may be sent to the control system 14, for example from a programming device, such as a teach pendant unit (TPU). Alternatively, the performance parameter may be predefined or the control system 14 may select the performance parameter.

One example of a performance parameter is a time for executing the movement paths 48a-48f. In this case, the zone group 44a-44h generating the shortest time for the TCP 26 to move from the first target point 42a to the fifth target point 42e may be selected. In some implementations, not only the fly-by zones 46b-46d affect this time. In case reorientation zones 50b-50d and/or secondary zones 52b-52d are used, the TCP 26 may have to slow down inside a fly-by zone 46b-46d to wait for the associated reorientation of the end effector 24 and/or the associated actuation of the secondary actuator 28, respectively.

A further example of a performance parameter is wear on the industrial device 10, or any subpart thereof, if executing the movement paths 48a-48f. One example of such wear is fatigue. In this case, the zone group 44a-44h generating the lowest wear on the manipulator 12 (and optionally on the secondary actuator 28) when the manipulator 12 moves from the first target point 42a to the fifth target point 42e may be selected.

A further example of a performance parameter is a maximum force or a maximum torque acting on the industrial device 10 if executing the movement paths 48a-48f. In this case, the zone group 44a-44h generating the lowest force or torque on the manipulator 12 (and optionally on the secondary actuator 28) when moving from the first target point 42a to the fifth target point 42e may be selected.

A further example of a performance parameter is a singularity parameter indicating an occurrence of singularity in the manipulator 12 if executing the movement paths 48a-48f. In this case, a zone group 44a-44h that does not cause the manipulator 12 to enter a singularity when moving from the first target point 42a to the fifth target point 42e may be selected.

The method then proceeds with providing a plurality of alternative zone groups, such as the zone groups 44a-44h. Optionally, one or more constraints can be provided and used when providing the alternative zone groups 44a-44h. The constraints may be provided either by the user 16 or by the control system 14. The same one or more constraints can be used for each zone group 44a-44h. Examples of such constraints comprise maximum speed and/or acceleration of the manipulator 12, maximum speed and/or acceleration of the secondary actuator 28, time steps of the control system 14, time steps of the manipulator motors 22, time steps of the secondary motors of the secondary actuator 28, and spatial constraints of the workspace of the industrial device 10.

Regardless of which performance parameter is used, simulations of a control of the industrial device 10 for each zone group 44a-44h are then performed. Based on the simulations, performance values of the selected performance parameter are determined for each zone group 44a-44h. Simulations may be performed by a simulation software program implemented in the control system 14, such as RobotStudio® by ABB. A machine learning algorithm may also be implemented in the control system 14 to improve the determination of the performance values. The machine learning algorithm may use the target points 42a-42e, the zone groups 44a-44h and the associated performance values as training data.

Optionally, interpolations may be made based on the performance values to provide further alternative zone groups 44a-44h. In this way, one or more further alternative zone groups 44a-44h can be determined iteratively. The interpolations may be made based on the previously determined performance values. The machine learning algorithm may be used also for such iterative provisions of further alternative zone groups 44a-44h. The simulations and determination of the performance values may then be repeated for the further alternative zone groups 44a-44h.

The performance values of the zone groups 44a-44h are then evaluated, e.g. compared with each other. The evaluation is made by the control system 14. The zone group 44a-44h evaluated to have the best performance value in some respect, is then selected. The movement path 48a-48f associated with the selected zone group 44a-44h is then executed by the manipulator 12.

By generating alternative zone groups 44a-44h, evaluating performance values of performance parameters, and selecting one of the zone groups 44a-44h for execution of the associated movement path 48a-48f based on the evaluations, the performance of the manipulator 12 can be improved. Since the definitions of the zones 46a-46e may be complex to the user 16, the method is of great advantage.

During execution of the movement path 48a-48f associated with the selected zone group 44a-44h by the manipulator 12, the method may continue to provide new or improved zone groups. For example, in case further target points are provided downstream of the fifth target point 42e, the method may generate further zone groups for one or more downstream target points during execution of the movement path 48a-48f.

Furthermore, an actual performance value of the performance parameter may be determined when the movement path 48a-48f associated with the selected zone group 44a-44h is executed by the manipulator 12. For example, in case the movement path 48a-48f is executed repeatedly, the control system 14 may log the travel time of the TCP 26 between the first and fifth target points 42a and 42e for one or more of the cycles. Based on these actual travel times, the control system 14 may continuously or repeatedly try to modify the zone group 44a-44h in parallel with the actual execution of the cycles to improve the performance value. This modification may for example comprise the use of an optimization algorithm, e.g. implemented in the control system 14.

Once the zone group 44a-44h performs good enough, the zone group 44a-44h may be stored in association with the movement path 48a-48f. Definitions of the movement path 48a-48f may be stored with float numbers. Thus, the next time the movement path 48a-48f, or a closely similar movement path, is generated or is to be executed, the stored zone group 44a-44h can automatically be selected for execution, or automatically be used in an initial set of best guesses of zone groups 44a-44h for evaluation of the performance value. A good enough performance of a zone group 44a-44h may be concluded if the performance value meets defined criterion, such as a cycle time below a predefined threshold value.

While the present disclosure has been described with reference to exemplary embodiments, it will be appreciated that the present invention is not limited to what has been described above. For example, it will be appreciated that the dimensions of the parts may be varied as needed. Accordingly, it is intended that the present invention may be limited only by the scope of the claims appended hereto.

1. A method of controlling an industrial device comprising a manipulator, the method-comprising including:
providing a plurality of consecutive target points for the manipulator;
providing a plurality of alternative zone groups, where each zone group includes at least one zone associated with a target point;
for each zone group, evaluating a performance value of a performance parameter of the industrial device, the performance parameter being associated with execution by the manipulator of a movement path associated with the target points and the at least one zone;
selecting one of the zone groups based on the evaluation; and
controlling the industrial device based on the selected zone group, the control including executing the movement path associated with the selected zone group by the manipulator.

2. The method according to claim 1, wherein each zone group comprises one or more fly-by zones, and wherein the performance parameter is associated with execution by the manipulator of a movement path created based on the target points and the at least one fly-by zone of the zone group.

3. The method according to claim 2, further comprising, for each zone group, creating a movement path based on the target points and the at least one fly-by zone of the zone group.

4. The method according to claim 3, wherein the evaluation is made based on the created movement paths.

5. The method according to claim 1, wherein the evaluation comprises, for each movement path, simulating the control of the industrial device.

6. The method according to claim 1, further comprising providing at least one additional zone group based on the evaluation, and wherein the selection is made also based on the at least one additional zone group.

7. The method according to claim 1, further comprising receiving a selection indicative of the performance parameter among a plurality of different performance parameters from a user prior to evaluating the performance values.

8. The method according to claim 1, further comprising:
determining an actual performance value of the performance parameter based on the control of the industrial device; and
modifying the selected zone group based on the actual performance value.

9. The method according to claim 1, wherein the at least one zone comprises one or more reorientation zones, and wherein the method further comprises includes controlling reorientation of an end effector of the manipulator based on the reorientation zones when executing the movement path by the manipulator.

10. The method according to claim 1, wherein the at least one zone comprises one or more secondary zones, and wherein the method further includes controlling actuation of a secondary actuator of the industrial device based on the secondary zones when executing the movement path by the manipulator.

11. A control system for controlling an industrial device comprising a manipulator, the control system including at least one data processing device and at least one memory having at least one computer program stored thereon, the at least one computer program having program code which, when executed by the at least one data processing device, causes the at least one data processing device to perform the steps of:
providing a plurality of consecutive target points for the manipulator;
providing a plurality of alternative zone groups, where each zone group includes at least one zone associated with a target point;
for each zone group, evaluating a performance value of a performance parameter of the industrial device, the performance parameter being associated with execution by the manipulator of a movement path associated with the target points and the at least one zone;
selecting one of the zone groups based on the evaluation; and
controlling the industrial device based on the selected zone group, the control having commanding execution of the movement path associated with the selected zone group by the manipulator.

12. The control system according to claim 11, wherein the at least one computer program further comprises program code which, when executed by the at least one data processing device, causes the at least one data processing device to perform the method wherein each zone group comprises one or more fly-by zones, and wherein the performance parameter is associated with execution by the manipulator of a movement path created based on the target points and the at least one fly-by zone of the zone group.

13. An industrial device comprising the manipulator and a control system including at least one data processing device and at least one memory having at least one computer program stored thereon, the at least one computer program having program code which, when executed by the at least one data processing device, causes the at least one data processing device to perform the steps of:
providing a plurality of consecutive target points for the manipulator;
providing a plurality of alternative zone groups, where each zone group includes at least one zone associated with a target point;
for each zone group, evaluating a performance value of a performance parameter of the industrial device, the performance parameter being associated with execution by the manipulator of a movement path associated with the target points and the at least one zone;
selecting one of the zone groups based on the evaluation; and
controlling the industrial device based on the selected zone group, the control having commanding execution of the movement path associated with the selected zone group by the manipulator.

14. The method according to claim 2, wherein the evaluation comprises, for each movement path, simulating the control of the industrial device.

15. The method according to claim 2, further comprising providing at least one additional zone group based on the evaluation, and wherein the selection is made also based on the at least one additional zone group.

16. The method according to claim 2, further comprising receiving a selection indicative of the performance parameter among a plurality of different performance parameters from a user prior to evaluating the performance values.

17. The method according to claim 2, further comprising:
determining an actual performance value of the performance parameter based on the control of the industrial device; and
modifying the selected zone group based on the actual performance value.

18. The method according to claim 2, wherein the at least one zone comprises one or more reorientation zones, and wherein the method further includes controlling reorientation of an end effector of the manipulator based on the reorientation zones when executing the movement path by the manipulator.

19. The method according to claim 2, wherein the at least one zone comprises one or more secondary zones, and wherein the method further includes controlling actuation of a secondary actuator of the industrial device based on the secondary zones when executing the movement path by the manipulator.
